(19) United States
(12) Patent Application Publication
(10) Pub. No.: US 2020/0371495 A1
(43) Pub. Date: Nov. 26, 2020

(54) AUTOMATED REAL-TIME HOLE CLEANING EFFICIENCY INDICATOR

(71) Applicant: Saudi Arabian Oil Company, Dhahran (SA)

(72) Inventors: Mohammed Murif Al-Rubaii, Dammam (SA); Abdullah Saleh Hussain Al-Yami, Dhahran (SA); Salem H. Al Gharbi, Dammam (SA)

(73) Assignee: Saudi Arabian Oil Company, Dhahran (SA)

(21) Appl. No.: 16/421,045

(22) Filed: May 23, 2019

(51) Int. Cl. G05B 19/416; E21B 44/00; E21B 47/08; E21B 45/00; E21B 21/08

(52) U.S. Cl. CPC G05B 19/416; E21B 44/00; G05B 2219/45129; E21B 45/00; E21B 21/08; E21B 47/08

(57) ABSTRACT

Real-time field data that is associated with a hydrocarbon reservoir drilling field is obtained. A carrying capacity index (CCI) and a cutting concentration annulus (CCA) are determined based on the real-time field data. In response to determining the CCI and CCA, the CCI is compared with a first predetermined value and the CCA is compared with a second predetermined value to obtain a comparison result. One or more parameters associated with the hydrocarbon reservoir drilling field are adjusted based on the comparison result through a user interface (UI).

### TECHNICAL FIELD

The present disclosure relates to oilfield exploration and, in particular, to monitoring and measuring the hole cleaning performance in downhole and surrounding environments.

### BACKGROUND

Inadequate hole cleaning can lead to costly drilling problems, such as mechanical pipe sticking, formation fracturing, excessive torque and drag on a drill string, and difficulties in logging and cementing. Optimization of hole cleaning remains one of the major challenges when planning and drilling high angled (that is, inclination angles greater than approximately 30 degrees from vertical) and extended reach wells. Optimal hole cleaning refers to the efficient removal of drill cuttings during drilling. For this condition to hold, many factors must be in place. To efficiently transport cuttings out of the hole, the transporting medium (drilling fluid) must be able to suspend the solid particles; also, there must be enough energy in the form of a motion to push the solids out of the hole.

### SUMMARY

The present disclosure describes techniques that can be used to design a model that automatically monitors and measures real-time hole cleaning performance. Specifically, the designed model combines the Carrying Capacity Index (CCI) and the Cutting Concentration in Annulus (CCA), and utilizes real-time input parameters for hole cleaning performance measures. The term “real-time” can correspond to events that occur within a specified period of time, such as within one minute, within one second, or within milliseconds.

In some implementations, a computer-implemented method includes: real-time field data that is associated with a hydrocarbon reservoir drilling field is obtained; a CCI and a CCA are determined based on the obtained real-time field data; the CCI is compared with a first predetermined value and the CCA is compared with a second predetermined value to obtain a comparison result; and one or more parameters associated with the hydrocarbon reservoir drilling field are adjusted through a user interface (UI).

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, the technique of developing a model based on a combination of CCI and CCA for hole cleaning optimization is not known to this field of art. The developed model has been validated using field data obtained while drilling challenging hole-sections. Further, the new automated hole cleaning model has a great impact on the effectiveness of hole cleaning and performance of drilling rates. It can avoid stuck pipes and alleviate the Equivalent Circulating Density (ECD) effect, effectively reduce torque and drag, and transport cuttings loaded in the annulus. In addition, the developed hole cleaning model achieves hole cleaning efficiency and well drilling performance that leads to cost-effectiveness and contributes to well delivery.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a flowchart of an example process for applying the designed model to hole sections with different mud systems, according to some implementations of the present disclosure.

FIG. 2A is an example of a graph illustrating a comparison result of the rate of the penetration (ROP) trend between an offset well applying the conventional hole cleaning method and a trial well, applying the designed model, according to some implementations of the present disclosure.

FIG. 2B is an example of a graph illustrating a comparison result of the mechanical specific energy (MSE) trend between an offset well applying the conventional hole cleaning method and a trial well, applying the designed model, according to some implementations of the present disclosure.

FIG. 2C is an example of a graph illustrating a comparison result of the torque trend between an offset well applying the conventional hole cleaning method and a trial well applying the designed model, according to some implementations of the present disclosure.

FIG. 2D is an example of a graph illustrating a comparison result of the standpipe pressure (SPP) trend between an offset well applying the conventional hole cleaning method and a trial well, applying the designed model, according to some implementations of the present disclosure.

FIG. 3 is a flowchart of an example method for monitoring and measuring hole cleaning performance using the designed model, according to some implementations of the present disclosure.

FIG. 4 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques that can be used to design a model that automatically monitors and measures real-time hole cleaning performance. Specifically, the designed apparatus model is based on a software model that combines the CCI and the CCA and utilizes real-time input parameters for hole cleaning performance measures. Various modifications, alterations, and permutations of the disclosed implementations can be made and will be readily apparent to those of ordinary skill in the art. The general principles defined may be applied to other implementations and applications without departing from the scope of the disclosure. In some instances, details unnecessary to obtain an understanding of the described subject matter may be omitted so as to not obscure one or more described implementations with unnecessary detail and such details are within the skill of one of ordinary skill in the art. The present disclosure is not intended to be limited to the described or illustrated implementations, but to be accorded the most extensive scope consistent with the described principles and features.

Integrating optimum drilling fluid properties with best drilling practices is important for a successful hole cleaning. Optimization of cuttings transport depends on many factors, such as the hole-angle, cutting, size, drill string rotation, drill pipe eccentricity, and optimization of bit hydraulics. A hole cleaning model can accurately predict the effects of a number of drilling variables. Among these variables, some can be designed during planning and controlled during drilling (so-called “controllable variables”) while others can be neither designed nor controlled. The controllable variables can be further categorized by considering whether they can be adjusted easily at a rigsite in order to combat a hole cleaning problem. Such controllable variables can include the flow rate, rate of penetration (ROP), mud rheology, and flow regime. These variables are considered the most important and therefore are used as main parameters, among others, for the proposed model in the present disclosure.

The present disclosure develops a new model that can be used to simultaneously monitor and measure hole cleaning in both vertical and deviated wells. The proposed model utilizes hydraulics software that is programmed specifically for oilfield applications to accurately determine optimal values for a series of drilling parameters under actual downhole conditions. The modeled parameter values are confirmed by real-time pressure-while-drilling (PWD) data. The immediate feedback from the modeling process allows the drilling engineers to optimize hole cleaning by several means, including adjusting surface mud properties to meet changing downhole conditions and adjusting mechanical parameters such as rate of penetration (ROP), flow rate, pipe-rotation speed, and tripping speed.

The proposed model is developed by combining real-time evaluations of CCA and CCI. Real-time field data, such as flow rate, ROP, and mud properties, are used as input to the developed model to calculate the values of CCA and CCI. By monitoring the output of CCA and CCI values, decisions could be made as to whether there is a need to adjust corresponding drilling parameters to optimize the hole cleaning performance. For example, it is known that annular cutting concentration is the main factor that causes pipe sticking, great torque, and drag. The greater the concentration of the cuttings, the greater the ECD, and the greater the probability of hole cleaning issues. Therefore, CCA is the parameter that should be considered for the cuttings transport in directional well drilling. Cutting concentration while circulating and drilling an annulus volume of a specified section length is dependent upon the variables such as ROP, flow rate, porosity and density of formation drilled, and drilling fluid density; that is, a greater ROP value requires greater flow velocity for cuttings transport due to increase in cuttings concentration in annulus. Based on the parameters as input, the concentration of cuttings in the fluid annulus can be calculated using equations such as:

$$C C A = \frac{R O P * {( HoleSize )}^{2}}{1471 * G P M * T R} \qquad eq . ( 1 )$$

where:
HoleSize represents the diameter of the wellbore (in feet (ft));
ROP represents the rate of penetration (drilling rate, in feet/hour (ft/hr));
GPM represents the flow rate (in gallons per minute (min)); and
TR represents the transport ratio and can be replaced by 0.55 as an initial value.

Likewise, CCI was initially developed empirically to provide a fast method of determining whether a vertical hole (<35 degrees from the true vertical) was being cleaned sufficiently to avoid trouble. The proposed model further bridges the gap between different formulas and can be used to predict hole cleaning irrespective of the hole-angle. Specifically, for vertical wells, the equations for calculating the CCI are:

$$\begin{matrix}CCI = \frac{density * K * V a}{400000} & eq . ( 2 ) \\ k = \frac{510 * {θ}_{300}}{51 {0}^{n}} & eq . ( 3 ) \\ {θ}_{300} = PV + YP & eq . ( 4 ) \\ {θ}_{600} = 2 * PV + YP & eq . ( 5 ) \\ n = 3.32 * log \frac{{θ}_{600}}{{θ}_{300}} & eq . ( 6 ) \\ {v}_{a} = \frac{24.5 * GPM}{π / 4} * [ {( holesize )}^{2} - {( pipeOD )}^{2} ] & eq . ( 7 )\end{matrix}$$

where:
density represents the density of the fluid (in pounds/gallon (lbs/gal));
K represents the consistency index (CI) (in centipoinse (cp));
θ₃₀₀ represents a viscosity reading at 300 revolutions per minute (rpm) (in cp);
θ₆₀₀ represents a viscosity reading at 600 rpm (in cp);
PV represents the plastic viscosity (in cp);
YP represents the yield point (in pounds/100 square footage (lbs/100 sqft));
Pipe OD represents the pipe diameters (in ft); and
vₐ represents the annular velocity (in cp).

For horizontal wells, the equations for calculating the CCI are:

$$\begin{matrix}CCI = \frac{K * TI}{3585 * A a * R F} & eq . ( 8 ) \\ TI = GPM * density * \frac{R F}{834.5 * 7.481} & eq . ( 9 ) \\ RF = \frac{P V}{Y P} + [ ( \frac{Y P}{P V} ) / 2 ] & eq . ( 10 ) \\ Aa = \frac{π}{4 * 1.44} * [ {( holesize )}^{2} - {( pipeOD )}^{2} ] & eq . ( 11 )\end{matrix}$$

where:
TI represents the transport index;
RF represents the rheology factor; and
Aa Represents the annuals areas (in square feet (ft²)).

The proposed model offers several advantages comparing to known software models in this field. First, the model is based on combining and simultaneously monitoring CCA and CCI. In addition, the model is combined with real-time input data to automatically generate real-time output. Second, the model is based on modified equations and can automatically monitor, measure, and direct drilling engineers to adjust parameters associated with a drilling field to improve the hole cleaning performance. For example, in the proposed model, the RF is modified so that it calculates automatically. Further, while CCI equations used in other known software models are only applicable in vertical hole-sections, the proposed model modifies the main CCI equation so that it can be implemented in all types of hole-sections.

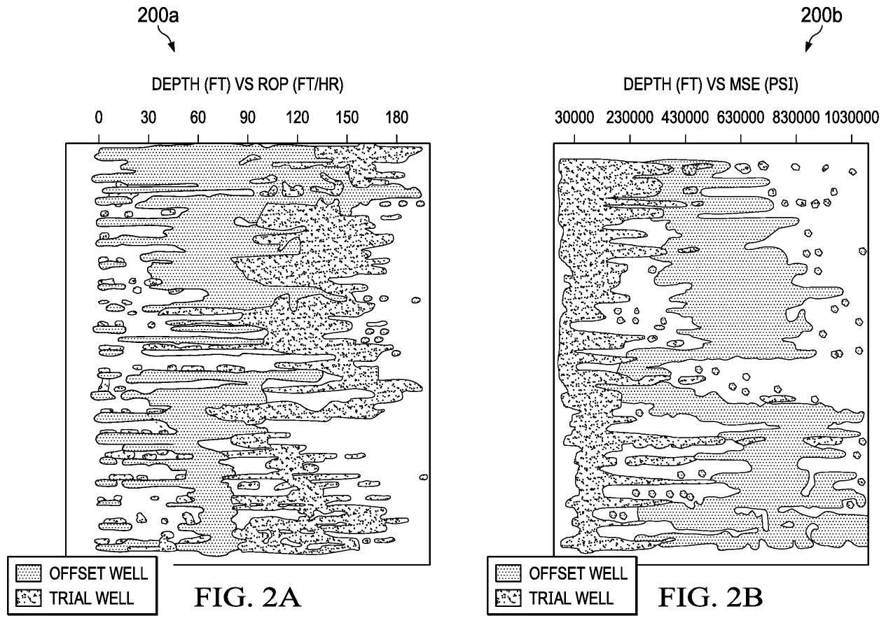

Compared to existing software models used for hole cleaning performance measuring, the proposed model is less expensive and more cost-efficient. The model has been tested on both water-based mud (WBM) and oil-based mud (OBM) with different values, and on rigs with different measurements and physical meanings. Outputs from these tests show that the model can produce good results with either WBM or OBM. Moreover, existing software models run with managed pressure drilling systems (which can be expensive). Some of these known models use artificial intelligence techniques. However, these models do not consider temperature effects and rig equipment limitations, nor can they tell if the current real-time values of mud properties ensure proper hole cleaning efficiency and need to be optimized. Moreover, the proposed model has been applied to real-world oil well productions and shows a significant improvement in the drilling practice. The model has been applied in different fields for four vertical hole-sections that have interval lengths of 2000 feet, 1200 feet, 400 feet, and 1800 feet, respectively; one horizontal section of 3000 feet interval length and one deviated hole section of 3500 feet interval length. The results were optimum and the impact of hole cleaning on ROP is significant and achieved optimally. For example, the drilling performance is improved by 55% (the ROP has increased 55%), stuck pipe incidents are mitigated, and wiper trips and reaming trips are eliminated. Details of these improvements are shown in FIG. 2 of the present disclosure.

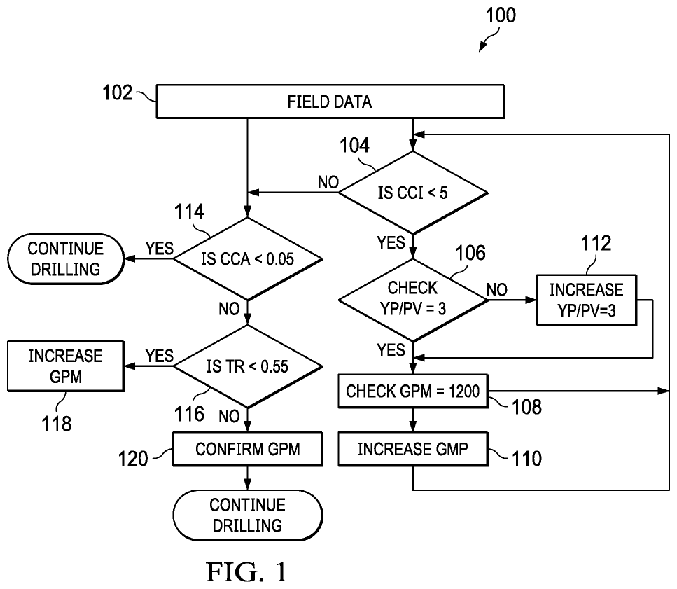

FIG. 1 is a flowchart of an example process 100 for applying the designed model to hole sections with different mud systems, according to some implementations of the present disclosure.

At 102, a set of field data is received at the model. In some implementations, the field data includes variables associated with the drilling field, such as the hole size of the wellbore, drilling pipe size, mud properties such as mud weight, PV, and YP, density of the drilling fluid, and other related parameters such as mechanical parameters, GPM, ROP, torque (that is, the movement required to rotate the pipe), RPM (that is, spindle speed, the rotation frequency of the spindle of the drilling machine, measured in revolution per minute (RPM)), WOB (that is, weight on bit, which is the amount of downward force exerted on the drilling bit provided by the thick-walled tubular pieces in the drilling assembly), and SPP (that is, standard pipe pressure, which is the summation of pressure loss in annulus, pressure loss in drill string, pressure loss in bottom hole assembly (BHA) and pressure loss across the bit).

In some implementations, some of these variables, such as ROP, hole-size, GPM, and TR, can be automatically extracted from a received surface/survey log. In some implementations, some of these variables, such as the density of the drilling fluid, annular velocity, and rheology factors can be automatically extracted from the received rheology log.

At 104, it is determined whether the CCI value is less than five. If it is determined that the CCI value is less than five, process 100 proceeds to 106.

At 106, it is determined whether the ratio of YP/PV is equal to three. If so, process 100 proceeds to 108. At 108, it is determined whether the GPM is equal to 1200. In some implementations, a greater GPM value is desirable, but the rig limitations of equipment are contributing in such cases too. If so, process 100 returns to 104 and the loop starts again.

Returning to 108, if it is determined that the GPM is less than 1200, process 100 proceeds to 110. At 110, the value of GPM is increased so that the value of CCI can reach five.

Returning to 106, if it is determined that the ratio of YP/PV is not equal to three, process 100 proceeds to 112. At 112, the ratio of YP/PV is increased to three. After 112, process 100 proceeds to 108.

Returning to 104, if it is determined that the CCI value is equal to or greater than five, process 100 proceeds to 114. At 114, it is determined whether the value of CCA is less than 0.05, and if so, the drilling process continues without changing any parameters. Otherwise, process 100 proceeds to 116.

At 116, it is determined whether the value of the TR is less than 0.55. If so, process 100 proceeds to 118. At 118, the value of GPM is increased. In some implementations, the GPM value is increased until the CCI value reaches the requirement of optimum CCI, for example, to a value of CCI that is at least five. Even a greater CCI value is always desirable; however, the GPM value is also controlled by the rig limitation.

Returning to 116, if it is determined that the value of the TR is equal to or greater than 0.55, process 100 proceeds to 120. At 120, the value of GPM is confirmed to ensure that the optimum value of GPM has been obtained, and the drilling continues.

In the present disclosure, threshold values for different parameters (such as CCI, CCA, TR, YP/PV) are determined based on experiments done in different drilling fields and under different conditions. For example, after finishing a study on a 16″ hole-section and performed implementation of the model in fields for different hole-sections (vertical, deviated, and horizontal), the desired threshold value for CCI is determined as five in a 16″ hole-section. This means that if the annulus of a drilled hole-section is less than the annulus of the hole-section of the 16″ hole section, a CCI value that is equal to five can ensure the optimum hole cleaning in various hole-sections for different sizes and types. Similarly, a determination that the threshold value of CCA is equal to 0.05 is made based on experience and literature to make an assumption that 0.05 is the maximum limit the model should adopt. However, if the solid removal equipment of a mud system is efficient enough, although this equipment is different from rig to rig, the optimum results can be ensured regardless of rig limitation by applying the model described in this disclosure. The CCA value may go up from 0.06 to 0.08. It is also noticed that when ROP has a value of 0.05 that the system has the smoothness with generated cuttings while drilling. In this way, maintaining CCI equal to five while simultaneously maintaining CCA equal to 0.05 ensures an efficient cleaning of generated cuttings (how to measure the efficiency). Likewise, the threshold value of YP/PV is a dominant factor of the rheology of drilling fluid that can control the consistency index and shear thinning. Applying a value of YP/PV equal to three can ensure the CCI is equal to five.

FIG. 2A is an example of a graph illustrating a comparison result 200a of the rate of penetration (ROP) trend between an offset well applying the conventional hole cleaning method and a trial well applying the designed model, according to some implementations of the present disclosure. ROP is defined as the speed at which a drill bit breaks the rock under it to deepen the borehole. ROP is one of several parameters that influence drilling efficiency. As shown in FIG. 2A, different ROP values are measured and compared for the offset well and the trial well each time at the same depth (in ft). When applying the conventional hole cleaning method to the offset well, most of the measured ROP values fall within a range of around 0 to 90 (ft/hr). When applying the designed model to the trial well, most of the measured ROP values fall within a range to 90 to 180 (ft/hr). The result shows that the ROP has improved more than 55% by implementing the designed model.

FIG. 2B is an example of a graph illustrating a comparison result 200b of the mechanical specific energy (MSE) trend between an offset well applying the conventional hole cleaning method and a trial well applying the designed model, according to some implementations of the present disclosure. MSE is the measure of the amount of energy input required to remove a unit volume of rock, expressed in units of energy input divided by volume removed. Minimizing MSE by optimizing controllable factors results in maximum ROP. Maximum efficiency can be found at the point when MSE is at its least, and it has been used in the industry as an efficiency measurement tool. As shown in FIG. 2B, different MSE values are measured and compared for the offset well and the trial well each time at the same depth (in ft). When applying the conventional hole cleaning method to the offset well, most of the measured MSE values fall within a range of around 230,000 to 1,030,000 pounds per square inch (psi). When applying the designed model to the trial well, most of the measured ROP values fall within a range of around 30,000 to 430,000 psi. The result shows that the MSE has been reduced by more than 50% by implementing the designed model.

FIG. 2C is an example of a graph illustrating a comparison result 200c of the torque trend between an offset well applying the conventional hole cleaning method and a trial well applying the designed model, according to some implementations of the present disclosure. The wellbore friction, and torque and drag between the drill string and the wellbore wall are among the most critical issues that limit the drilling industry from going beyond a certain measure depth. As shown in FIG. 2C, torque values are measured and compared for the offset well and the trial well each time at the same depth (in ft). When applying the conventional hole cleaning method to the offset well, most of the measured torque values fall within a range of around 5 to 15 kilopounds-foot (klb-ft). When applying the designed model to the trial well, most of the measured torque values fall within a range of around 0 to 10 klb-ft. The result shows that the torque has been reduced by 36% by implementing the designed model.

FIG. 2D is an example of a graph illustrating a comparison result 200d of the standpipe pressure (SPP) trend between an offset well applying the conventional hole cleaning method and a trial well applying the designed model, according to some implementations of the present disclosure. When drilling fluid circulates, pressure drop takes place due to friction between the fluid and the surface in contact. The total pressure drop that occurs due to fluid friction is termed as standpipe pressure or SPP. As shown in FIG. 2D, SPP values are measured and compared for the offset well and the trial well each time at the same depth (in ft). When applying the conventional hole cleaning method to the offset well, most of the measured SPP values fall within a range of around 2,500 to 3,500 psi. When applying the designed model to the trial well, most of the measured SPP values fall within a range of around 2,000 to 2,500 psi. The result shows that the SPP has reduced about 27% by implementing the designed model.

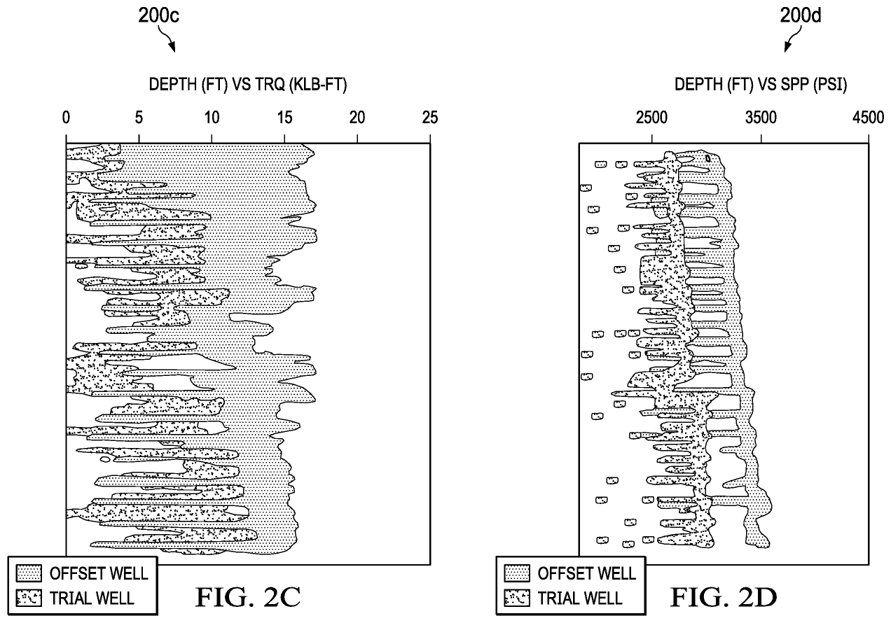

FIG. 3 is a flowchart of an example method for monitoring and measuring hole cleaning performance using the designed model, according to some implementations of the present disclosure. For clarity of presentation, the description that follows generally describes method 300 in the context of the other figures in this description. However, it will be understood that method 300 can be performed, for example, by any suitable system, environment, software, and hardware, or a combination of systems, environments, software, and hardware, as appropriate. In some implementations, various steps of method 300 can be run in parallel, in combination, in loops, or in any order.

At 302, real-time field data that is associated with a hydrocarbon reservoir-drilling field is obtained.

At 304, a CCI and a CCA are determined based on the obtained real-time field data.

In some implementations, the CCA is calculated according to equation (1). In some implementations, the CCI for a vertical well is calculated according to equations (2)-(7). In some implementations, the CCI for a horizontal well is calculated according to equations (8)-(11).

At 306, in response to determining the CCI and CCA, the determined CCI is compared with a first predetermined value and the determined CCA is compared with a second predetermined value to obtain a comparison result.

In some implementations, comparing the determined CCI with a first predetermined value and the determined CCA with a second predetermined value to obtain a comparison result includes determining whether the CCI is less than a first predetermined value. In response to a determination that the CCI is less than the first predetermined value, it is further determined whether a ratio of a YP and a PV is equal to a third predetermined value and whether a GPM is equal to a fourth predetermined value. In response to a determination that the CCI is at least equal to the first predetermined value, it is also determined whether the CCA is less than a second predetermined value.

In such implementations, method 300 further includes if it is determined that the CCI is at least equal to the first predetermined value, determining whether a TR is less than a fifth predetermined value.

At 308, one or more parameters associated with the hydrocarbon reservoir-drilling field are adjusted based on the comparison result through a user interface (UI).

In some implementations, adjusting one or more parameters based on the comparison result includes if the comparison result is that the CCI less than the first predetermined value, increasing the GPM until the value of the CCI reaches the first predetermined value. If the comparison result is that the CCI is at least equal to the first predetermined value, the CCA is at least equal to the second predetermined value, and the TR is less than the fifth predetermined value; increasing the GPM until a value of the TR reaches the fifth predetermined value.

In such implementations, method 300 further includes if it is determined that the CCI is less than the first predetermined value and the ratio of YP to PY is not equal to the fourth predetermined value, increasing a value of YP and decreasing the value of PY until a value of the ratio of YP to PY reaches the fourth predetermined value.

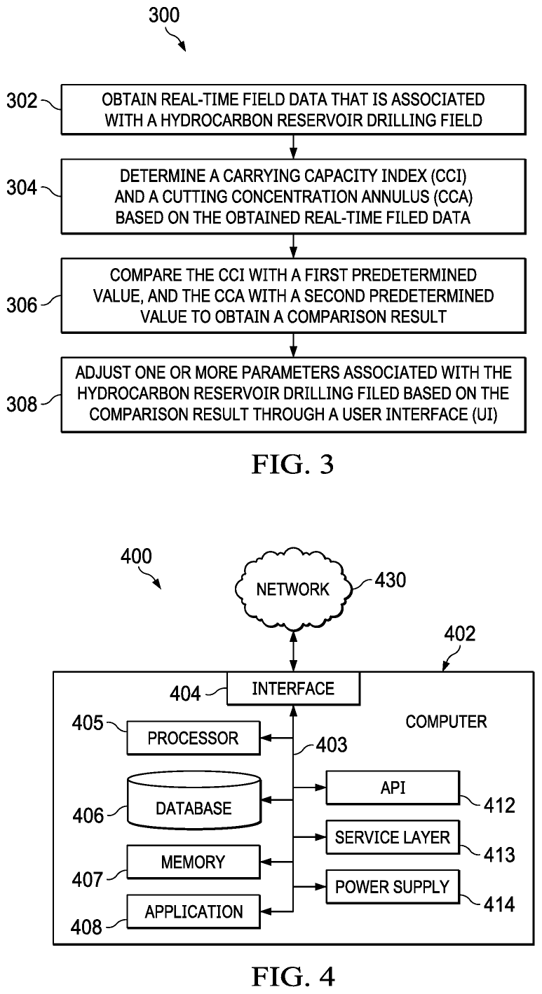

FIG. 4 is a block diagram of an example computer system 400 used to provide computational functionalities associated with described algorithms, methods, functions, processes, flows, and procedures described in the present disclosure, according to some implementations of the present disclosure. The illustrated computer 402 is intended to encompass any computing device such as a server, a desktop computer, a laptop/notebook computer, a wireless data port, a smartphone, a personal data assistant (PDA), a tablet computing device, or one or more processors within these devices, including physical instances, virtual instances, or both. The computer 402 can include input devices such as keypads, keyboards, and touch screens that can accept user information. In addition, the computer 402 can include output devices that can convey information associated with the operation of the computer 402. The information can include digital data, visual data, audio information, or a combination of information. The information can be presented in a graphical user interface (UI) (or GUI).

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

The computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 403. In some implementations, any or all of the components of the computer 402, including hardware or software components, can interface with each other or the interface 404 (or a combination of both), over the system bus 403. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs.

The service layer 413 can provide software services to the computer 402 and other components (whether illustrated or not) that are communicably coupled to the computer 402. The functionality of the computer 402 can be accessible for all service consumers using this service layer. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 413 can be implemented as child or sub-modules of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and can manipulate data to perform the operations of the computer 402, including operations using algorithms, methods, functions, processes, flows, and procedures as described in the present disclosure.

The computer 402 also includes a database 406 that can hold data for the computer 402 and other components connected to the network 430 (whether illustrated or not). For example, database 406 can be an in-memory, conventional, or a database storing data consistent with the present disclosure. In some implementations, database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

The application 408 can be an algorithmic software engine providing functionality according to particular needs, desires, or particular implementations of the computer 402 and the described functionality. For example, application 408 can serve as one or more components, modules, or applications. Further, although illustrated as a single application 408, the application 408 can be implemented as multiple applications 408 on the computer 402. In addition, although illustrated as internal to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion and management circuits, including recharging, standby, and power management functionalities. In some implementations, the power-supply 414 can include a power plug to allow the computer 402 to be plugged into a wall socket or a power source to, for example, power the computer 402 or recharge a rechargeable battery.

There can be any number of computers 402 associated with, or external to, a computer system containing computer 402, with each computer 402 communicating over network 430. Further, the terms “client,” “user,” and other appropriate terminology can be used interchangeably, as appropriate, without departing from the scope of the present disclosure. Moreover, the present disclosure contemplates that many users can use one computer 402 and one user can use multiple computers 402.

Described implementations of the subject matter can include one or more features, alone or in combination.

For example, in a first implementation, a computer-implemented method, including: obtaining real-time field data that is associated with a hydrocarbon reservoir drilling field; determining a CCI and a cutting CCA based on the real-time field data; in response to determining the CCI and CCA, comparing the CCI with a first predetermined value and the determined CCA with a second predetermined value to obtain a comparison result; and adjusting one or more parameters associated with the hydrocarbon reservoir drilling field based on the comparison result through a UI.

The foregoing and other described implementations can each, optionally, include one or more of the following features:

A first feature, combinable with any of the following features, where the CCI for a vertical well is calculated according to equations (2)-(7).

A second feature, combinable with any of the previous or following features, where the CCA is calculated according to equation (1).

A third feature, combinable with any of the previous or following features, where comparing the CCI with a first predetermined value and the determined CCA with a second predetermined value to obtain a comparison result includes determining whether the CCI is less than a first predetermined value; if it is determined that the CCI is less than the first predetermined value, determining whether a ratio of a yield point (YP) and a plastic viscosity (PV) is equal to a third predetermined value, and whether a flow rate (measured by GPM) is equal to a fourth predetermined value; and if it is determined that the CCI is at least equal to the first predetermined value, determining whether the CCA is less than a second predetermined value.

A fourth feature, combinable with any of the previous or following features, the method further including if it is determined that the CCI is at least equal to the first predetermined value, determining whether a transport ratio (TR) is less than a fifth predetermined value.

A fifth feature, combinable with any of the previous or following features, where directing drilling engineers to adjust one or more parameters associated with the hydrocarbon reservoir drilling field includes: if it is determined that the CCI is less than the first predetermined value, directing the drilling engineers to increase the GPM until a value of the CCI reaches the first predetermined value; and if it is determined that the CCI is at least equal to the first predetermined value, the CCA is at least equal to the second predetermined value, and the TR is less than the fifth predetermined value, directing the drilling engineers to increase the GPM until a value of the TR reaches the fifth predetermined value.

A sixth feature, combinable with any of the previous or following features, the method further including if it is determined that the CCI is less than the first predetermined value and a ratio of YP to PY is not equal to the fourth predetermined value, directing the drilling engineers to increase a value of YP and decrease a value of PY until a value of the ratio of YP to PY reaches to the fourth predetermined value.

In a second implementation, a non-transitory, computer-readable medium storing one or more instructions executable by a computer system to perform operations including: obtaining real-time field data that is associated with a hydrocarbon reservoir drilling field; determining a CCI and a cutting CCA based on the real-time field data; in response to determining the CCI and CCA, comparing the CCI with a first predetermined value and the determined CCA with a second predetermined value to obtain a comparison result; and adjusting one or more parameters associated with the hydrocarbon reservoir drilling field based on the comparison result through a UI.

The foregoing and other described implementations can each, optionally, include one or more of the following features:

A first feature, combinable with any of the following features, where the CCI for a vertical well is calculated according to equations (2)-(7).

A second feature, combinable with any of the previous or following features, where the CCA is calculated according to equation (1).

A third feature, combinable with any of the previous or following features, where comparing the CCI with a first predetermined value and the determined CCA with a second predetermined value to obtain a comparison result includes determining whether the CCI is less than a first predetermined value; if it is determined that the CCI is less than the first predetermined value, determining whether a ratio of a yield point (YP) and a plastic viscosity (PV) is equal to a third predetermined value, and whether a flow rate (GPM) is equal to a fourth predetermined value; and if it is determined that the CCI is at least equal to the first predetermined value, determining whether the CCA is less than a second predetermined value.

A fourth feature, combinable with any of the previous or following features, the method further including if it is determined that the CCI is at least equal to the first predetermined value, determining whether a transport ratio (TR) is less than a fifth predetermined value.

A fifth feature, combinable with any of the previous or following features, where directing drilling engineers to adjust one or more parameters associated with the hydrocarbon reservoir drilling field includes: if it is determined that the CCI is less than the first predetermined value, directing the drilling engineers to increase the GPM until a value of the CCI reaches the first predetermined value; and if it is determined that the CCI is at least equal to the first predetermined value, the CCA is at least equal to the second predetermined value, and the TR is less than the fifth predetermined value, directing the drilling engineers to increase the GPM until a value of the TR reaches the fifth predetermined value.

A sixth feature, combinable with any of the previous or following features, the method further including if it is determined that the CCI is less than the first predetermined value and a ratio of YP to PY is not equal to the fourth predetermined value, directing the drilling engineers to increase a value of YP and decrease a value of PY until a value of the ratio of YP to PY reaches to the fourth predetermined value.

In a third implementation, a computer-implemented system, including one or more processors and a non-transitory computer-readable storage medium coupled to the one or more processors and storing programming instructions for execution by the one or more processors, the programming instructions instructing the one or more processors to perform operations including: obtaining real-time field data that is associated with a hydrocarbon reservoir drilling field; determining a CCI and a cutting CCA based on the real-time field data; in response to determining the CCI and CCA, comparing the CCI with a first predetermined value and the determined CCA with a second predetermined value to obtain a comparison result; and adjusting or more parameters associated with the hydrocarbon reservoir drilling field based on the comparison result through a UI.

The foregoing and other described implementations can each, optionally, include one or more of the following features:

A first feature, combinable with any of the following features, where the CCI for a vertical well is calculated according to equations (2)-(7).

A second feature, combinable with any of the previous or following features, where the CCA is calculated according to equation (1).

A third feature, combinable with any of the previous or following features, where comparing the CCI with a first predetermined value and the determined CCA with a second predetermined value to obtain a comparison result includes determining whether the CCI is less than a first predetermined value; if it is determined that the CCI is less than the first predetermined value, determining whether a ratio of a yield point (YP) and a plastic viscosity (PV) is equal to a third predetermined value, and whether a flow rate (GPM) is equal to a fourth predetermined value; and if it is determined that the CCI is at least equal to the first predetermined value, determining whether the CCA is less than a second predetermined value.

A fourth feature, combinable with any of the previous or following features, the method further including if it is determined that the CCI is at least equal to the first predetermined value, determining whether a transport ratio (TR) is less than a fifth predetermined value.

A fifth feature, combinable with any of the previous or following features, where directing drilling engineers to adjust one or more parameters associated with the hydrocarbon reservoir drilling field includes: if it is determined that the CCI is less than the first predetermined value, directing the drilling engineers to increase the GPM until a value of the CCI reaches the first predetermined value; and if it is determined that the CCI is at least equal to the first predetermined value, the CCA is at least equal to the second predetermined value, and the TR is less than the fifth predetermined value, directing the drilling engineers to increase the GPM until a value of the TR reaches the fifth predetermined value.

A sixth feature, combinable with any of the previous or following features, the method further including if it is determined that the CCI is less than the first predetermined value and a ratio of YP to PY is not equal to the fourth predetermined value, directing the drilling engineers to increase a value of YP and decrease a value of PY until a value of the ratio of YP to PY reaches to the fourth predetermined value.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
obtaining real-time field data that is associated with a hydrocarbon reservoir drilling field;
determining a carrying capacity index (CCI) and a cutting concentration annulus (CCA) based on the real-time field data;
in response to determining the CCI and CCA, comparing the CCI with a first predetermined value and the determined CCA with a second predetermined value to obtain a comparison result; and
adjusting one or more parameters associated with the hydrocarbon reservoir drilling field based on the comparison result through a user interface (UI).

2. The computer-implemented method of claim 1, wherein the CCA is calculated according to equation:
$$C C A = \frac{R O P * {( HoleSize )}^{2}}{1471 * G P M * T R}$$
wherein:
HoleSize represents a diameter of a wellbore;
ROP represents a rate of penetration;
GPM represents a flow rate; and
TR represents a transport ratio.

3. The computer-implemented method of claim 1, wherein the CCI for a vertical well is calculated according to equations:
$$\begin{matrix}CCI = \frac{density * K * V a}{400000} \\ k = \frac{510 * {θ}_{300}}{51 {0}^{n}} \\ {θ}_{300} = PV + YP \\ {θ}_{600} = 2 * PV + YP \\ n = 3.32 * log \frac{{θ}_{600}}{{θ}_{300}} \\ {v}_{a} = \frac{24.5 * GPM}{π / 4} * [ {( holesize )}^{2} - {( pipeOD )}^{2} ]\end{matrix}$$
wherein:
density represents the density of a drilling fluid;
K represents a consistency index;
θ₃₀₀ represents a viscosity reading at 300 Rpm;
θ₆₀₀ represents a viscosity reading at 600 Rpm;
PV represents a plastic viscosity;
YP represents a yield point;
Pipe OD represents a pipe diameter; and
vₐ represents a annular velocity;
and
wherein the CCI for a horizontal well is calculated according to equations:
$$\begin{matrix}CCI = \frac{K * TI}{3585 * A a * R F} \\ TI = GPM * density * \frac{R F}{834.5 * 7.481} \\ RF = \frac{P V}{Y P} + [ ( \frac{Y P}{P V} ) / 2 ] \\ Aa = \frac{π}{4 * 1.44} * [ {( holesize )}^{2} - {( pipeOD )}^{2} ]\end{matrix}$$
wherein:
TI represents a transport index;
RF represents a Rheology factor; and
Aa represents an annuals area.

4. The computer-implemented method of claim 1, wherein comparing the CCI with a first predetermined value and the determined CCA with a second predetermined value to obtain a comparison result comprises:
determining whether the CCI is less than a first predetermined value;
if it is determined that the CCI is less than the first predetermined value, determining whether a ratio of a yield point (YP) and a plastic viscosity (PV) is equal to a third predetermined value, and whether a flow rate (GPM) is equal to a fourth predetermined value; and
if it is determined that the CCI is at least equal to the first predetermined value, determining whether the CCA is less than a second predetermined value.

5. The computer-implemented method of claim 4, further comprising:
if it is determined that the CCI is at least equal to the first predetermined value, determining whether a transport ratio (TR) is less than a fifth predetermined value.

6. The computer-implemented method of claim 5, wherein adjusting one or more parameters associated with the hydrocarbon reservoir drilling field comprises:
if it is determined that the CCI is less than the first predetermined value, directing the drilling engineers to increase the GPM until a value of the CCI reaches the first predetermined value; and
if it is determined that the CCI is at least equal to the first predetermined value, the CCA is at least equal to the second predetermined value, and the TR is less than the fifth predetermined value, directing the drilling engineers to increase the GPM until a value of the TR reaches the fifth predetermined value.

7. The computer-implemented method of claim 6, further comprising:
if it is determined that the CCI is less than the first predetermined value and a ratio of YP to PY is not equal to the fourth predetermined value, directing the drilling engineers to increase a value of YP and decrease a value of PY until a value of the ratio of YP to PY reaches to the fourth predetermined value.

8. A non-transitory, computer-readable medium storing one or more instructions executable by a computer system to perform operations comprising: obtaining real-time field data that is associated with a hydrocarbon reservoir drilling field;
determining a carrying capacity index (CCI) and a cutting concentration annulus (CCA) based on the real-time field data;
in response to determining the CCI and CCA, comparing the CCI with a first predetermined value and the CCA with a second predetermined value to obtain a comparison result; and
adjusting one or more parameters associated with the hydrocarbon reservoir drilling field based on the comparison result through a user interface (UI).

9. The non-transitory, computer-readable medium of claim 8, wherein the CCI for a vertical well is calculated according to equations:
$$\begin{matrix}CCI = \frac{density * K * V a}{400000} \\ k = \frac{510 * {θ}_{300}}{51 {0}^{n}} \\ {θ}_{300} = PV + YP \\ {θ}_{600} = 2 * PV + YP \\ n = 3.32 * log \frac{{θ}_{600}}{{θ}_{300}} \\ {v}_{a} = \frac{24.5 * GPM}{π / 4} * [ {( holesize )}^{2} - {( pipeOD )}^{2} ]\end{matrix}$$
wherein:
density represents the density of a drilling fluid;
K represents a consistency index;
θ₃₀₀ represents a viscosity reading at 300 Rpm;
θ₆₀₀ represents a viscosity reading at 600 Rpm;
PV represents a plastic viscosity;
YP represents a yield point;
Pipe OD represents a pipe diameter; and
vₐ represents a annular velocity;
and
wherein the CCI for a horizontal well is calculated according to equations:
$$\begin{matrix}CCI = \frac{K * TI}{3585 * A a * R F} \\ TI = GPM * density * \frac{R F}{834.5 * 7.481} \\ RF = \frac{P V}{Y P} + [ ( \frac{Y P}{P V} ) / 2 ] \\ Aa = \frac{π}{4 * 1.44} * [ {( holesize )}^{2} - {( pipeOD )}^{2} ]\end{matrix}$$
wherein:
TI represents a transport index;
RF represents a Rheology factor; and
Aa represents an annuals area.

10. The non-transitory, computer-readable medium of claim 8, wherein the CCA is calculated according to equation:
$$C C A = \frac{R O P * {( HoleSize )}^{2}}{1471 * G P M * T R}$$
wherein:
HoleSize represents a diameter of a wellbore (in ft);
ROP represents a rate of penetration (drilling rate, in ft/hr);
GPM represents a flow rate (in gallon per mints); and
TR represents a transport ratio.

11. The non-transitory, computer-readable medium of claim 8, wherein comparing the CCI with a first predetermined value and the determined CCA with a second predetermined value to obtain a comparison result comprises:
determining whether the CCI is less than a first predetermined value;
if it is determined that the CCI is less than the first predetermined value, determining whether a ratio of a yield point (YP) and a plastic viscosity (PV) is equal to a third predetermined value, and whether a flow rate (GPM) is equal to a fourth predetermined value; and
if it is determined that the CCI is at least equal to the first predetermined value, determining whether the CCA is less than a second predetermined value.

12. The non-transitory, computer-readable medium of claim 11, further comprising:
if it is determined that the CCI is at least equal to the first predetermined value, determining whether a transport ratio (TR) is less than a fifth predetermined value.

13. The non-transitory, computer-readable medium of claim 12, wherein adjusting one or more parameters associated with the hydrocarbon reservoir drilling field comprises:
if it is determined that the CCI is less than the first predetermined value, directing the drilling engineers to increase the GPM until a value of the CCI reaches the first predetermined value; and
if it is determined that the CCI is at least equal to the first predetermined value, the CCA is at least equal to the second predetermined value, and the TR is less than the fifth predetermined value, directing the drilling engineers to increase the GPM until a value of the TR reaches the fifth predetermined value.

14. The non-transitory, computer-readable medium of claim 13, further comprising:
if it is determined that the CCI is less than the first predetermined value and a ratio of YP to PY is not equal to the fourth predetermined value, directing the drilling engineers to increase a value of YP and decrease a value of PY until a value of the ratio of YP to PY reaches to the fourth predetermined value.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
obtaining real-time field data that is associated with a hydrocarbon reservoir drilling field;
determining a carrying capacity index (CCI) and a cutting concentration annulus (CCA) based on the real-time field data;
in response to determining the CCI and CCA, comparing the CCI with a first predetermined value and the CCA with a second predetermined value to obtain a comparison result; and
adjusting one or more parameters associated with the hydrocarbon reservoir drilling field based on the comparison result through a user interface (UI).

16. The computer-implemented system of claim 15, wherein the CCI for a vertical well is calculated according to equations:
$$\begin{matrix}CCI = \frac{density * K * V a}{400000} \\ k = \frac{510 * {θ}_{300}}{51 {0}^{n}} \\ {θ}_{300} = PV + YP \\ {θ}_{600} = 2 * PV + YP \\ n = 3.32 * log \frac{{θ}_{600}}{{θ}_{300}} \\ {v}_{a} = \frac{24.5 * GPM}{π / 4} * [ {( holesize )}^{2} - {( pipeOD )}^{2} ]\end{matrix}$$
wherein:
density represents the density of a drilling fluid;
K represents a consistency index;
θ₃₀₀ represents a viscosity reading at 300 Rpm;
θ₆₀₀ represents a viscosity reading at 600 Rpm;
PV represents a plastic viscosity;
YP represents a yield point;
Pipe OD represents a pipe diameter; and
vₐ represents a annular velocity;
and
wherein the CCI for a horizontal well is calculated according to equations:
$$\begin{matrix}CCI = \frac{K * TI}{3585 * A a * R F} \\ TI = GPM * density * \frac{R F}{834.5 * 7.481} \\ RF = \frac{P V}{Y P} + [ ( \frac{Y P}{P V} ) / 2 ] \\ Aa = \frac{π}{4 * 1.44} * [ {( holesize )}^{2} - {( pipeOD )}^{2} ]\end{matrix}$$
wherein:
TI represents a transport index;
RF represents a Rheology factor; and
Aa represents an annuals area.

17. The computer-implemented system of claim 15, wherein the CCA is calculated according to equation:
$$C C A = \frac{R O P * {( HoleSize )}^{2}}{1471 * G P M * T R}$$
wherein:
HoleSize represents a diameter of a wellbore;
ROP represents a rate of penetration;
GPM represents a flow rate; and
TR represents a transport ratio.

18. The computer-implemented system of claim 15, wherein comparing the CCI with a first predetermined value and the determined CCA with a second predetermined value to obtain a comparison result comprises:
determining whether the CCI is less than a first predetermined value;
if it is determined that the CCI is less than the first predetermined value, determining whether a ratio of a yield point (YP) and a plastic viscosity (PV) is equal to a third predetermined value, and whether a flow rate (GPM) is equal to a fourth predetermined value; and
if it is determined that the CCI is at least equal to the first predetermined value, determining whether the CCA is less than a second predetermined value.

19. The computer-implemented system of claim 18, further comprising:
if it is determined that the CCI is at least equal to the first predetermined value, determining whether a transport ratio (TR) is less than a fifth predetermined value.

20. The computer-implemented system of claim 19, wherein adjusting one or more parameters associated with the hydrocarbon reservoir drilling field comprises:
if it is determined that the CCI is less than the first predetermined value, directing the drilling engineers to increase the GPM until a value of the CCI reaches the first predetermined value; and
if it is determined that the CCI is at least equal to the first predetermined value, the CCA is at least equal to the second predetermined value, and the TR is less than the fifth predetermined value, directing the drilling engineers to increase the GPM until a value of the TR reaches the fifth predetermined value.
